(19) United States
(12) Patent Application Publication
(10) Pub. No.: US 2009/0037501 A1
(43) Pub. Date: Feb. 5, 2009

(54) METHOD AND SYSTEM FOR MANAGING MEMORY FOR A PROGRAM USING AREA

(76) Inventors: Hiroyasu NISHIYAMA, Kawasaki (JP); Kei NAKAJIMA, Chigasaki (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/182,301

(22) Filed: Jul. 30, 2008

(30) Foreign Application Priority Data
Aug. 3, 2007 (JP) 2007-203283

(51) Int. Cl. G06F 12/00; G06F 9/46; G06F 12/02

(52) U.S. Cl. 707/206; 718/100; 707/E17.01; 711/E12.001; 711/E12.002

(57) ABSTRACT

If garbage collection is executed in every thread-local heap in order to secure processing responsiveness, a memory area may be fragmented or collectable areas may be reduced as the program execution proceeds. To overcome such problems, memory is divided into an area where thread specific data is allocated and an area where referenceable data from other threads is allocated, and is managed separately. More specifically, data that is referenced specifically by each thread is allocated to a thread-local heap, while data that is referenced from other threads is allocated to a global heap.

### BACKGROUND OF THE INVENTION

1. Field of the Invention

The present invention relates to a memory management method for use by a computer executing multiple programs concurrently, and the computer.

2. Description of the Related Arts

In a system such as an application program (business application) executed by a server that processes requests from outside, the program in response to the received requests is divided into units called threads, and multiple threads are executed concurrently. A thread is the unit of sequential execution, and program threads constituting a program are characterized by sharing a memory area.

Such an application program is programmed in an object-oriented programming language like Java (a registered trademark of Sun Microsystems, Inc. USA). Recent programming languages incorporate memory management functionality with garbage collection (hereinafter abbreviated as “GC”) in which a system (in the case of Java, called as a run time system, Java virtual machine, runtime environment or the like) determines and automatically collects unnecessary memory for executing subsequent programs out of dynamically allocated memory area.

A conventionally used GC usually stops all threads being executed in order to collect memory area because if there is a thread being executed in the course of collection task by GC, it is necessary to decide whether or not a collection target area is being used by the thread that is being executed at that point, and unfortunately the decision is not easy to make.

To stop threads being executed during GC means low responsiveness of processing. Therefore, time to be required stopping all threads during GC becomes an important issue in some applications such as an on-line trading system where fast responsiveness is valued.

As part of GC techniques for avoiding stopping a program by GC, T. Domani et al., in Thread-Local Heaps for Java, In Proceedings of the International Symposium on Memory Management, 2002, proposed that a runtime system should create a thread-local heap as data storage for each thread and that other threads should not be stopped while GC is performed on a certain thread-local heap. According to this technique, data within a thread-local heap is flagged individually if reference from data or objects that can be accessed by another thread is possible. Thread-specific GC process is then executed only on the data with no flag. Before certain data gets into a referable condition by other threads, a thread having created that data sets a flag. Since the data that can possibly be referenced from other threads is identified through flag setting, data referenced only by a thread-local heap can be identified and some of the data that is unnecessary for executing subsequent programs can be collected without considering operation of other threads.

### SUMMARY OF THE INVENTION

As data existing in a certain thread specific local heap, a conventional GC targeting on each thread specific local heap sets a flag to data that can be referenced from data or objects of other threads and collects some of unmarked (no flag setting) data that is not necessary for executing subsequent programs. At this time, the marked data can neither be collected nor migrated to another area within its local heap. This is because other threads can possibly reference the marked data within the corresponding local heap while the collection of local heaps (during GC). The constraint in data migration within a thread-local heap results in fragmentation of the collected memory area. In other words, the collected memory area, i.e., a free area, consists of little ones. Also since the marked data increases, collectable area within the thread specific local heaps is reduced as the execution of programs proceeds, and eventually GC cannot be carried out on the thread specific local heaps. In such cases, all related threads are stopped and those thread specific local heaps are garbage collected.

If thread specific local heaps, except for the referenceable data from other threads, are garbage collected in order to secure processing responsiveness as noted before, it poses two problems: area fragmentation and a decrease in collectable areas as program execution proceeds.

On the contrary, the present invention is characterized by dividing memory into an area where thread specific data (objects) are allocated and an area where data referenceable by other threads is allocated, and by managing the memory area accordingly.

An aspect of the invention is therefore to provide a memory management method which creates, in memory corresponding to a program, thread-local heaps corresponding to more than one thread operating in parallel; one for each thread, and a global heap to be shared by threads into a memory, such that data that is referenced from each thread is allocated to a thread-local heap and data that is referenced from other threads, not the respective threads with specifically allocated data, is allocated to the global heap.

Another aspect of the invention is to provide a memory management method based on which, if data having been allocated to thread-local heaps is referenced from other threads, not the respective threads with specifically allocated data for their own, referenceable data is migrated to the global heap before the reference takes place.

An aspect of the invention is to provide a computer including: a memory that includes, corresponding to a program, a respective thread-local heap for each of plural threads and a global heap to be shared by threads; and a processor that executes each thread in parallel, allocates data referenced from each thread to a thread-local heap, and allocates data referenced from other threads, not the respective threads with specifically allocated data, to the global heap.

By dividing memory into thread-local heaps to which thread-specific data is allocated and a global heap where referenceable data by other threads is allocated, garbage collection can be executed with respect to the thread-local heaps and fragmentation of the memory area can be avoided. Moreover, according to one embodiment of the invention, by allocating data that can be referenced from other threads to the global heap, the reduction of the collectable area along with program execution is settled. Further, according to another embodiment of the invention, although garbage collection may be executed on thread-local heaps, other threads continue their execution, thereby ensuring processing responsiveness.

### BRIEF DESCRIPTION OF THE DRAWINGS

FIG. 1 is a schematic view of a language processing system implemented in a computer;

FIG. 2 is a schematic view of a computer implemented with a language processing system;

FIG. 3 shows one example of data allocation in a thread-local heap;

FIG. 4 shows one example of data allocation in a thread-local heap;

FIG. 5 illustrates fragmentation of a free area of a thread-local heap;

FIG. 6 shows one example of a thread-local heap having no collectable area;

FIG. 7 shows one example of data allocation in a global heap having been created;

FIG. 8 shows one example of data migration in a global heap having been created;

FIGS. 9A and 9B illustrate how to avoid fragmentation of a free area of a thread-local heap;

FIG. 10 is a flow chart of processing steps to execute instruction interpretation;

FIG. 11 is a flow chart of processing steps to migrate data into a global heap;

FIG. 12 is a flow chart of processing steps of memory allocation into thread-local heaps and a global heap;

FIG. 13 is a flow chart of processing steps to change a data allocation heap; and

FIG. 14 shows one example of a program that designates the allocation of a global heap.

### DESCRIPTION OF THE EMBODIMENTS

The best embodiment for carrying out the invention lies in the fact that memory is divided into an area where thread specific data (objects) are allocated and an area where data referenceable by other threads is allocated.

More specifically, the invention relates to memory management method which creates, in memory corresponding to a program, thread-local heaps corresponding to more than one thread operating in parallel; one for each thread, and a global heap to be shared by threads, such that data that is referenced from each thread is allocated to a thread-local heap and data that is referenced from other threads, not the respective threads with specifically allocated data for their own, is allocated to the global heap.

If data having been allocated to thread-local heaps is to be referenced from other threads, not the respective threads with specifically allocated data for their own, referenceable data are migrated to the global heap before the reference takes place.

In addition, the invention relates to a computer including: a memory that includes, corresponding to a program, a respective thread-local heap for each of plural threads and a global heap to be shared by threads; and a processor that executes each thread in parallel, allocates data referenced from each thread to a thread-local heap, and allocates data referenced from other threads, not the respective threads with specifically allocated data for their own, to the global heap.

### Embodiment 1

One embodiment of the present invention will now be described with reference to the accompanying drawings.

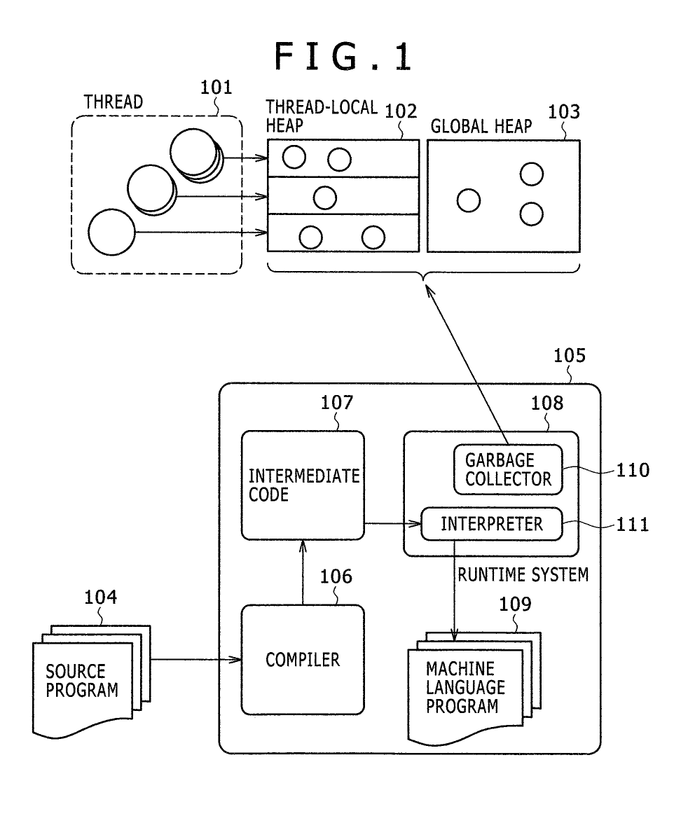

FIG. 1 is a schematic view of a so-called language processing system 105 implemented in a computer. A source program 104 described in an object-oriented programming language such as Java for example is converted to intermediate code 107 (byte code in Java) by a compiler 106. The intermediate code 107 is interpreted and executed by an interpreter 111 in a runtime system 108 (in Java, this is called as Java virtual machine (JavaVM), Java runtime environment, or the like). The intermediate code is not only interpreted and executed by the interpreter 111 each time, it may also be converted into a machine language program 109 by a JIT (Just-In-Time) Compiler. The runtime system 108 virtualizes the conversion into machine language and execution thereof, which looks like, to a user, programs being executed on the runtime system 108.

The runtime system 108 generates one or more threads (execution unit) 101 for each program. And a respective thread-local heap 102 is generated for each thread 101. The thread-local heap 102 is an area for storing data (object) generated by the execution of threads (this can be said that an object is stored in the area). This embodiment also generates a global heap 103 shared by threads 101 to store and reference data. Cooperative programs are operated or otherwise executed in one runtime system 108. Therefore, the global heap 103 is prepared in correspondence to the runtime system 108. Each thread-local heap 102 and the global heap 103 become targets of garbage collection by a garbage collector 110 of the runtime system 108. Although garbage collection is for exploiting an unused memory area by programs (threads), it is also effective for expanding any continuously usable memory area by collecting a memory area (fragmented memory areas) in an inter-data gap (including an inter-program gap).

Since the garbage collector 110 that performs garbage collection targeting on each thread-local heap 102 and the global heap 103 as noted earlier is assembled in the runtime system (i.e., is executed by the runtime system 108), one cannot control the timing for executing garbage collection from any program.

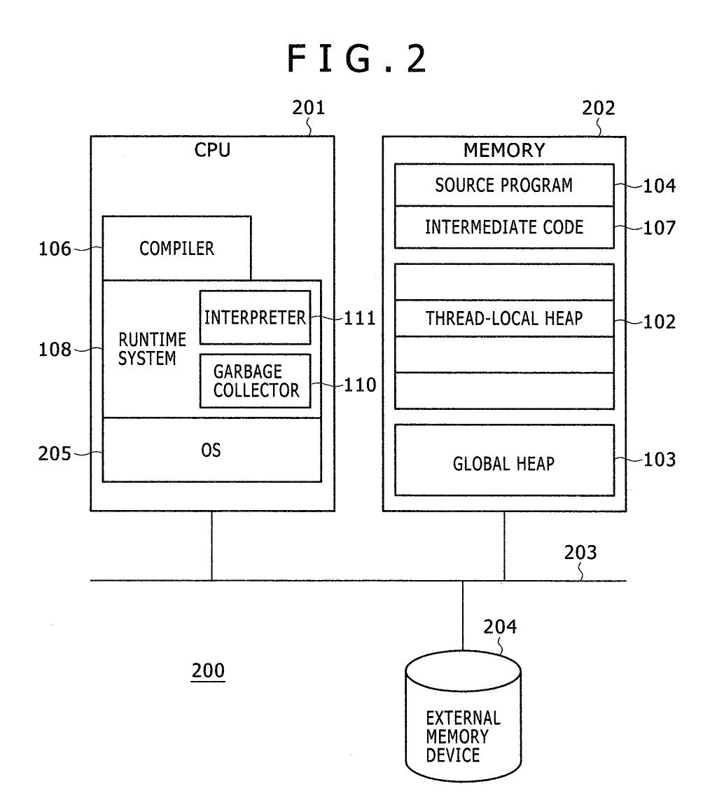

FIG. 2 is a schematic view of a computer 200 provided with the language processing system 105 and memory areas required for operation of the system. In other words, FIG. 2 shows the required configuration to explain this embodiment. It is obvious to those who are skilled in that art that the configuration may be a flat form such as a personal computer or portable device.

In the computer 200 shown in FIG. 2, CPU (processor) 201, memory 202, and an external memory unit 204 such as a disc are connected via a bus 203. The memory 202 stores a source program 104 and an intermediate code 107, and is reserved for thread-local heaps 102 and a global heap 103. Depending on the configuration of the computer 200, capacity of the memory 202, specification of the runtime environment (runtime system 108), or the like, the source program 104 and the intermediate code 107 may be stored in the external memory unit 204.

The runtime system 108 and the compiler 106 are operated in OS 205 under the CPU 201. That is, the OS 205, the runtime system 108 and the compiler 106 are stored in the memory 202 or in the external memory unit 204 (not shown), and are executed by the CPU 201. The CPU portion 201 in FIG. 2 shows program configurations being executed. Explanations on operation of the computer 200 including the interpreter 111 and garbage collector 110 in the runtime system 108 are already provided in FIG. 1 so they will be omitted herein.

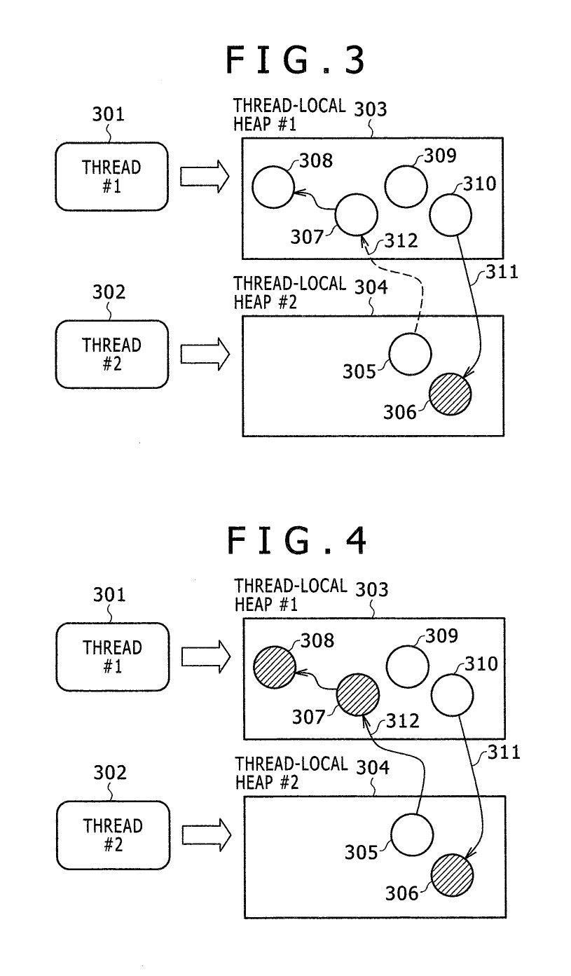

In order to clarify the usefulness or utility of the global heap 103, the following will now explain, with reference to FIGS. 3 and 4, a case where no global heap 103 is available. In the interest of brevity of explanation, a thread-local heap (#1) 303 corresponding to a thread (#1) 301 and a thread-local heap (#2) 304 corresponding to a thread (#2) 302 will be explained.

Data (objects) 307 to 310 exist in the thread-local heap 303, and data 305 and 306 exist in the thread-local heap 304. In the drawing, the data are indicated in circle. A solid-line arrow between data represents inter-data reference relationship, and a dashed line arrow represents a reference relationship to be created by an instruction in execution. The tail of an arrow indicates a source, and the head of an arrow indicates a target. A hatching circle represents data being referenced from data that exists in other thread-local heaps. This data will be called “global” data hereinafter. In FIG. 3, the target data 306 is global data because reference 311 from the data 310 in the thread-local heap 303 to the data 311 in the thread-local heap 304 is available.

FIG. 3 shows an attempt to create reference 312 from the data 305 in the thread-local heap 304 to the data 307 in the thread-local heap 303. FIG. 4 shows a state after the reference 312 is created. In response to the creation of the reference 312, the target data 307 and its accessible data 308 are marked as global data. “Accessible” means that there is a chain of reference relationship. Because the marked global data can possibly be referenced from the data in other thread-local heaps, it has to be excluded from targets of garbage collection by the garbage collector 110. In other words, the data 307 and 308 in the thread-local heap 303 and the data 306 in the thread-local heap 304 are exempt from collection (this involves data deletion and making its data storage area available for a new use) and data migration. Since it is always possible that the marked global data may be referenced from data in other thread-local heaps in execution, it cannot migrate even within a thread-local heap.

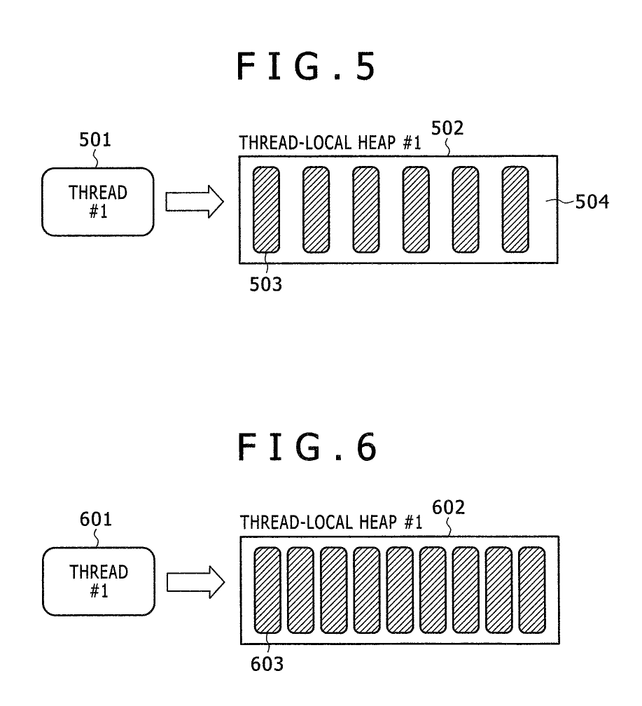

FIG. 5 depicts occurrence of newly available free area in a thread-local heap, i.e., fragmentation of a free area. More specifically, FIG. 5 shows a thread-local heap 502 corresponding to a thread 501 and illustrates that global data 503 and free areas (unused areas or collected data areas) 504 exist in the local heap 502. Although the free areas 504 in the thread-local heap 502 exist non-continuously as a result of garbage collection, since the global data 503 is not to be migrated as noted before, they cannot be combined and integrated to a large data storage area. That is, a process called compaction or defrag cannot be executed.

FIG. 6 depicts a thread-local heap 602 corresponding to a thread 601 which is filled with global data 603. The global data in the thread-local heap 602 is not a target for local collection (that is, global data is excluded from targets for the collection of data in thread-local heaps), so the collection process needs to be done while all threads are in a stop state.

As opposed to the problems of fragmentation of free area (usable area) in a thread-local heap and a decrease in collectable areas that are explained in use of FIG. 3 through FIG. 6, FIG. 10 through FIG. 12 will now explain processing steps to overcome such problems.

FIG. 10 describes a process in the interpreter that is associated with interpretation execution of an instruction. An instruction set or instruction format sometimes needs to be changed according to kind of language or runtime environment, but neither of them is concerned here.

In step 1000, the interpreter 111 checks whether an instruction pointed to by a register PC is a pointer store instruction like “obj1.f=obj2”. The register PC stores storage addresses of instructions (intermediate codes) to be executed later. “obj1.f=obj2” implies that data that a pointer obj1 points to references data that a pointer obj2 points to. The pointer herein may be an address of the memory 202 or a relative address from a predetermined base point. In result of checking, if the instruction is not a pointer store instruction, the process proceeds to step 1040 to execute the conventional instruction interpretation process and is finished.

On the other hand, if the checking result tells that the instruction is a pointer store instruction, the interpreter 111 checks whether the data pointed by the pointer obj1 is allocated to the global heap 103 and whether the data pointed by the pointer obj2 is allocated to the thread-local heap 102. In other words, in step 1004, the interpreter 111 checks whether the pointer obj1 points to the global heap 103 and the pointer obj2 points to the thread-local heap 102. If No, the process proceeds to step 1040 to execute the conventional instruction interpretation process and is finished. Here, suppose that “isGlobal(obj)” is a function to verify that the data the pointer obj points to is allocated at the global heap 103 and that “isLocal(obj)” is a function to verify that the data the pointer obj points to is allocated to the thread-local heap 102.

If the decision is realized as a result of checking, it means that the data that is pointed by the pointer obj1 and allocated in the global heap 103 references the data that is pointed by the pointer obj2 and allocated in the thread-local heap 102. Therefore, since the data pointed by the pointer obj2 is highly likely to be shared among threads, it needs to be migrated to the global heap 103.

In step 1010, a set (S) of data that is accessible from the data that the moving target pointer obj2 points to is obtained. As noted earlier, “accessible” means that there is a chain in reference relationship. In step 1015, the execution of threads that belong to a thread group stops. The thread group consists of plural threads that operate in one runtime system 108.

Also those who are skilled in the art can easily conceive that the thread group can be created as follows, depending on the nature of an application. Several program groups may be organized correspondingly to the threads that operate in the runtime system 108, and a specific local heap is created in respective thread group for each of the program groups, and a global heap shared by those thread groups is created. Alternatively, it is also possible that several program groups may be organized correspondingly to the threads that operate in the runtime system 108, and a specific local heap is created correspondingly to each thread, and global heaps are created for each program group if a reference relationship exists among data in the respective global heaps. Moreover, global heaps may be created over plural runtime systems. These are properly selected by the nature an application, and any skilled person in the art can easily perceive that technical concepts behind them are the same.

Next in step 1020, the data that belongs to the set (S) is migrated to the global heap 103, and a pointer of the target to which the data pointed by the pointer obj2 is to be migrated is labeled to obj2′. In step 1025 the execution of threads having been stopped is resumed, and in step 1030 obj2 is substituted with obj2′ as a pointer of data from which the data pointed by the pointer obj1 is referenced.

The data in the thread-local heap 102 can be referenced only from data of threads within a corresponding thread group. In the case that there is a respective thread-local heap 102 for each thread, reference is possible only from data of that thread. On the other hand, the data in the global heap 103 can be referenced only from data of other threads that share the global heap 103 together. Therefore, in the case of referencing the data pointed by the pointer obj2 from the data pointed by the pointer obj1, it becomes possible to cause the data that is referenced directly or indirectly through a reference relationship chain from the data pointed by the pointer obj1 to be referenced from data of other threads. Accordingly, referenceable data from other threads' data is migrated to the global heap 103 from the thread-local heap 102 before the data is referenced from other threads' data, such that one can guarantee that the data in the thread-local heap 102 is not going to be referenced from threads other than its corresponding thread. In step 1035, the interpreter 111 updates an address of the PC to a new address of an instruction to be executed next, and then completes the interpretation execution process with respect to one instruction.

Since the step 1040 in FIG. 10 is nothing but the conventional interpreter processing included in the runtime system 108, all of the other processing steps in FIG. 10 may be arranged to be executed prior to the step 1040. In this manner, data that can possibly be referenced from data of other threads or from data of threads which belong to another thread group is migrated to the global heap 103, and the garbage collection function (this function overcomes problems of data collection and fragmentation of a usable area) can fully be demonstrated on the thread-local heap 102.

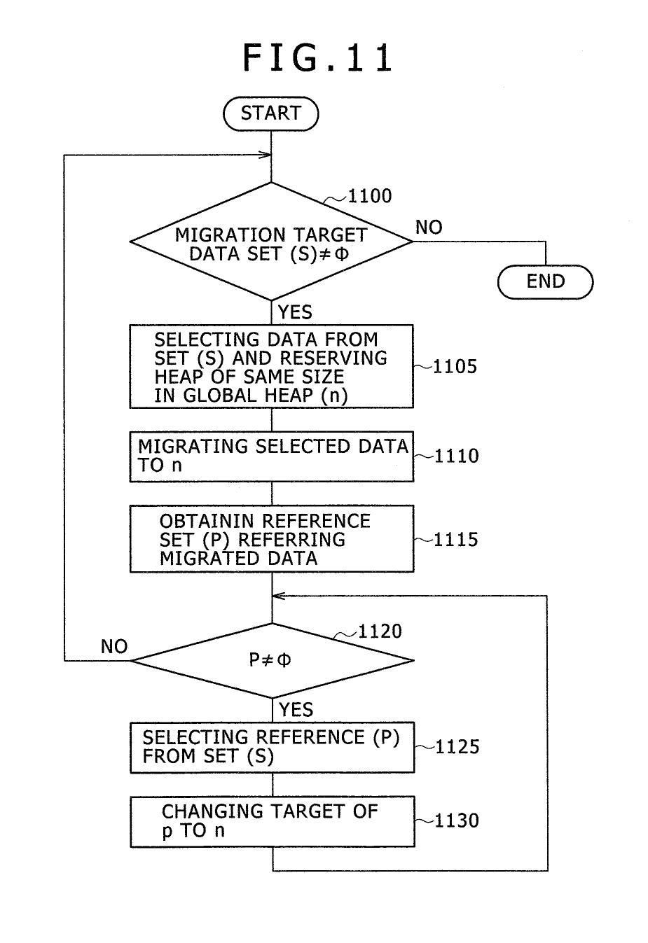

Referring to FIG. 11, the following will now explain the migration of data of the set (S) to the global heap 103 as noted in step 1020 of FIG. 10. In step 1100, it is checked whether the set (S) of data migrating to the global heap 103 is an empty set (φ). If so, there is no data to be migrated so the process is finished. However, if the set (S) is not an empty set, in step 1105, a data is selected from the set (S), an area in size of the data is reserved in the global heap 103, and a pointer pointing to the reserved area is called “n”. Then, in step 1110, the selected data from the set (S) migrates to the area that the pointer n points.

In step 1115, a reference set (P) referencing the migrated data in step 1110 is obtained. In step 1120, it is checked whether the reference set (P) is an empty set (φ). If so, it means there is no reference to be made according to the migration of data that is selected as a target for migration (i.e., there is no chain of reference in the migrated data), the process proceeds to step 1100 to handle the next data to be migrated. However, if the reference set (P) turns out to be an empty set (φ), in step 1125, one reference is selected from it, and the selected reference is called “p”. In step 1130, the target of data pointed by the reference (p) is changed to “n”, and the process proceeds to step 1120.

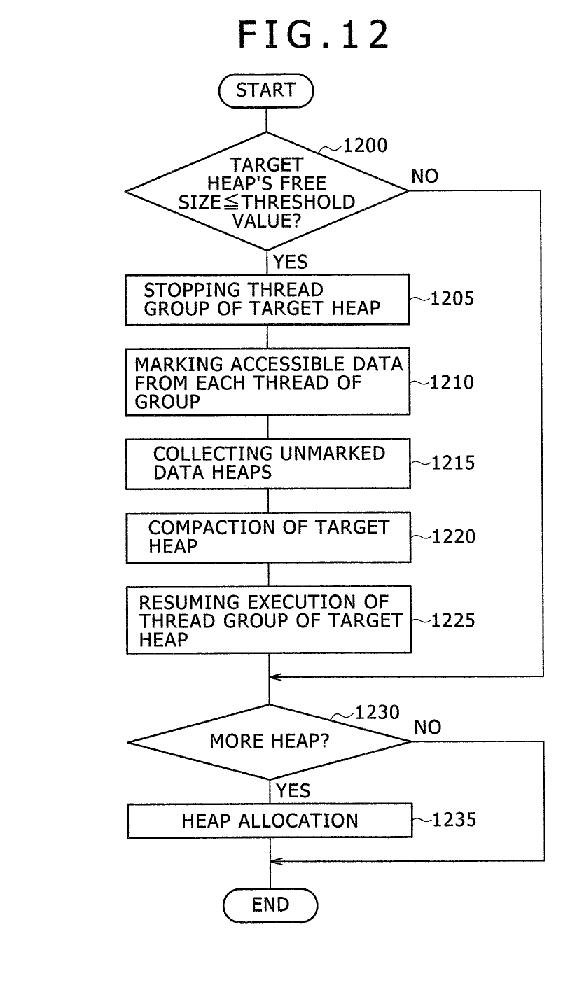

FIG. 12 describes processing steps of how the runtime system 108 allocates memory as the thread-local heaps 102 and the global heap 103. The target area of explanation is either an individual thread-local heap 102 or a global heap 103.

In step 1200, the runtime system 108 checks whether the size of a free area in the target area is a predetermined threshold value or below. The threshold value may vary by a target area. In particular, the threshold value of the global heap 103 may be different from that of the thread-local heap 102. If “No” in step 1200, the process proceeds to step 1230.

On the other hand, if “Yes” in step 1200, each thread of a thread group corresponding to the target area stops in step 1205. In step 1210, data that is accessible from each of threads constituting the thread group is marked. One should notice that marking herein differs from flag that represents that data can be referenced from plural threads. In step 1215, non-marked data is then collected to a data area that is unnecessary to execute subsequent programs. Any inaccessible data from each thread cannot be referenced in the execution of subsequent programs. That is, it becomes an unused area. In step 1220, all unused areas including collected areas are integrated together. In other words, while remaining data in the target area migrates within the target area, free areas are integrated. In step 1225, the execution of threads within the thread group is resumed.

In step 1230, it is checked whether the target area needs an additional area. If so, in step 1235, an area is additionally allocated. In the case that the processing of FIG. 12 premises the allocation of additional area, the checking step (i.e. step 1230) is not required.

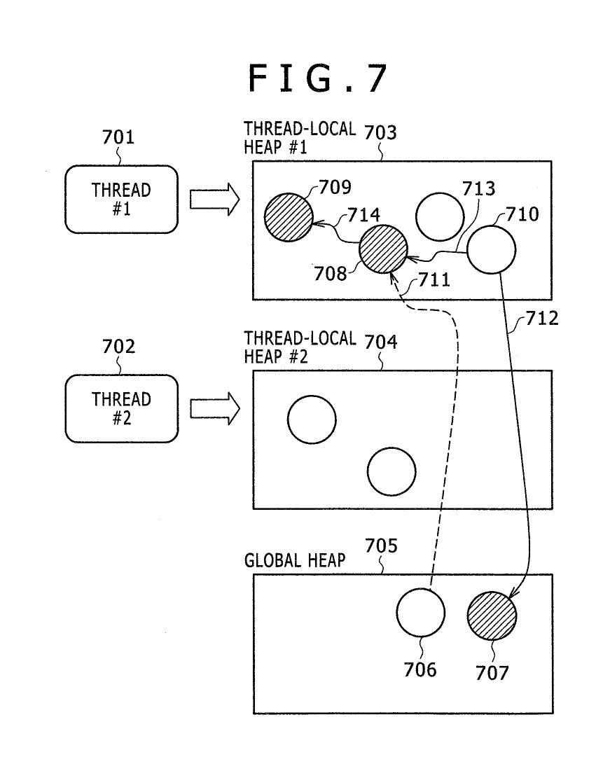

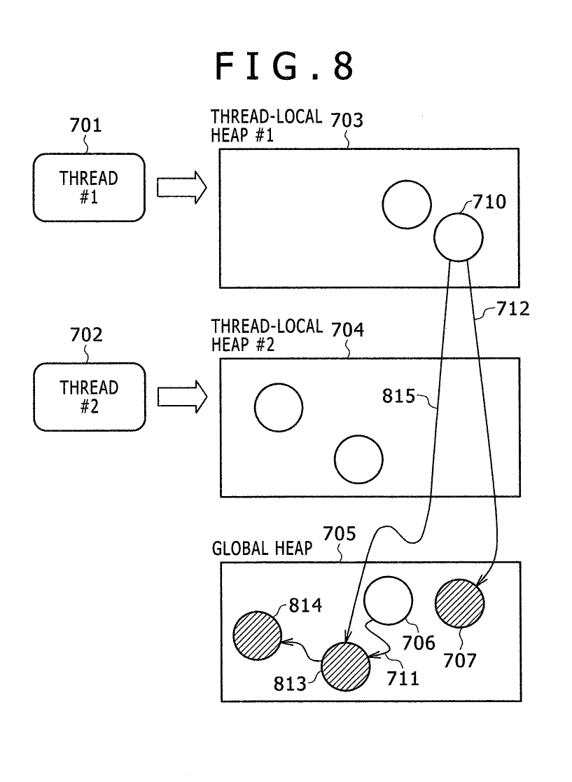

A specific example of the process in FIG. 10 and FIG. 11 will now be described in use of FIG. 7 and FIG. 8. FIGS. 7 and 8 show data allocation to thread-local heaps 703 and 704 corresponding to thread (#1) 701 and thread (#2) 702, and data allocation to a global heap 705. Data 707 shared in plural threads 701 and 702 is allocated to the global heap 705. In the drawings, the data are indicated in circle. A solid-line arrow between data represents inter-data reference relationship, and a dashed line arrow represents a reference relationship to be created by an instruction in execution. The tail of an arrow indicates a source, and the head of an arrow indicates a target. A hatching circle represents global data that is referenced from data existing in other thread-local heaps or in the global heap.

The following explanation will be based on the case illustrated in FIG. 7, where reference 711 is to be created from the data 706 allocated to the global heap 705 to the data 708 in the thread-local heap 703 corresponding to the thread 701. In step 1000 of FIG. 10, suppose that an instruction pointed to by PC is “obj1.f=obj2”, and obj1 is a pointer pointing to the data 706, and obj2 is a pointer pointing to the data 708. At this time, the decision in step 1000 is realized. Because the data 706 pointed by the pointer obj1 is allocated to the global heap 705 while the data 708 indicated by the pointer obj2 is allocated to the thread-local heap 703, the decision in step 1005 is also realized. In step 1010, a data set (including the data 708 itself) that can be accessible from the data pointed by the pointer obj2, e.g., S={708, 709}, is obtained. In step 1015, the thread 701 and thread 702 sharing the global heap 705 stop. In step 1020, the data 708 and data 709 included in the set (S) are migrated to the global heap 705.

In step 1100 of FIG. 11, since the migration target data set (S)={708, 709} is not an empty set, the data 708 is selected for migration, and a data area with the same size of the data 708 is reserved in the global heap 705, and a pointer for that data is labeled as “n”. The data 708 migrates to an area the pointer n points to, and the migrated data is labeled as 813. That is, the data 813 becomes the one the pointer n points to.

In step 1115, a reference set (P) referring the migrated data 708, e.g., P={711,713}, is obtained as noted earlier in FIGS. 7 and 8. In step 1120, it turns out that the reference set (P) is not an empty set. Therefore, in step 1125, one reference (p) is selected out of the reference set (P). The selected pointer is labeled as 711 (i.e., p=711) herein. The reference 711 from the data 706 to the data 708 changes to a reference to the data 813. Going back to step 1120, the selected reference is set to 713 (i.e., p=713). Since data pointed by the reference 713 is the migrated data 708, in step 1130, the reference 713 is changed to a reference corresponding to the pointer (n) that points to the data 813 obtained after migration of the data 708. That is to say, the reference 713 changes to a reference 815 that points to the data 813. In order to go back to step 1120, since the reference set (P) is an empty set, the process from 1100 starts all over again for data 709 to be migrated next.

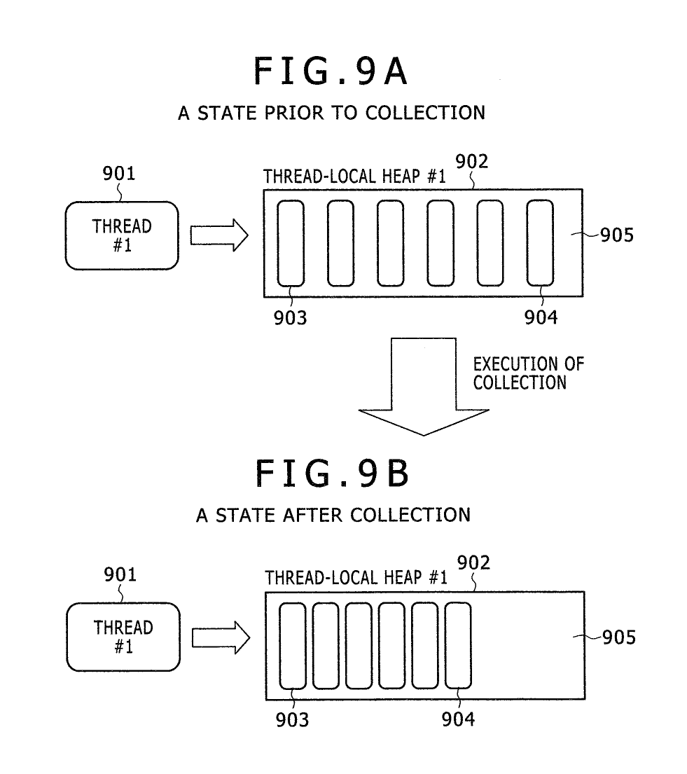

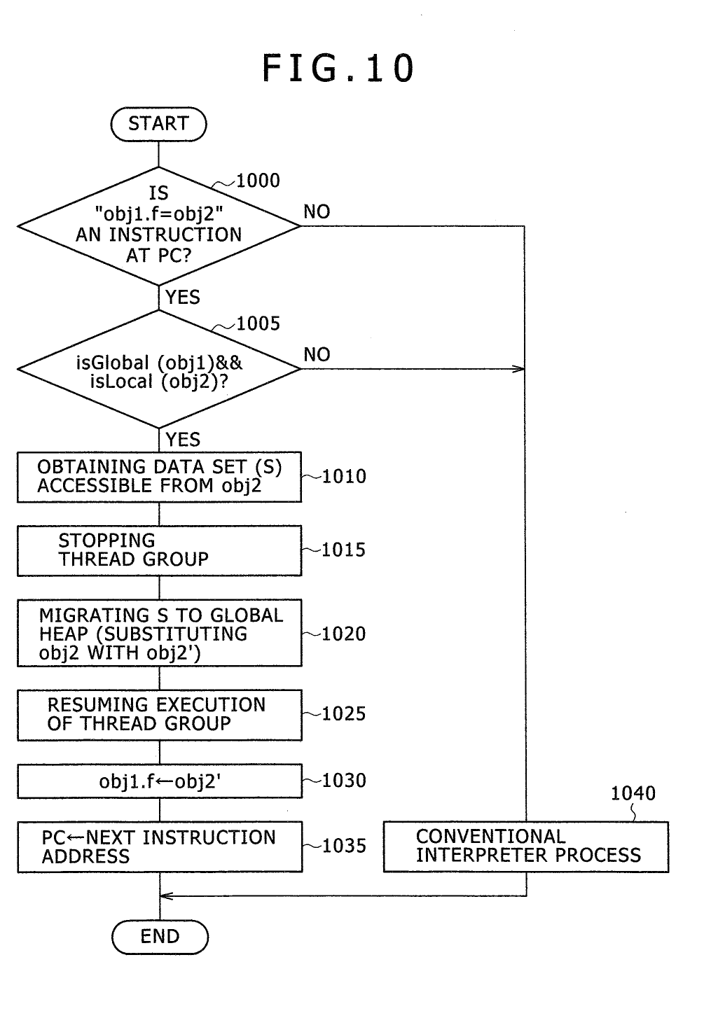

FIGS. 9A and 9B illustrate how to handle fragmentation of a free area. Referring to FIGS. 9A and 9B, there exists a thread-local heap 902 corresponding to a thread 901, and data 903 to 904 and a free area 902 exist in this thread-local heap. In particular, FIGS. 9A and 9B depicts a state that the data area is collected in step 1215 of FIG. 12, and the free area is fragmented. That is, the state in FIG. 12 shows a state where free areas are integrated by carrying out step 1220, in other words, remaining data in the target area is migrated within the target area.

According to this embodiment, memory is divided into an area to which thread specific data is allocated (i.e., a thread-local heap), and an area to which referenceable data from other threads is allocated (i.e., a global heap), such that garbage collection can be executed on the thread-local heap and fragmentation of an area can be avoided.

Moreover, according to this embodiment, by allocating referenceable data from other threads to the global heap, it becomes possible to resolve the problem associated with a decrease in collectable areas that occurs as the program execution proceeds.

In addition, by maintaining other threads in execution state while garbage collection proceeds in the thread-local heaps, responsiveness of the process can be guaranteed.

### Embodiment 2

As for the instruction execution process shown in FIG. 10, if reference is to be made from the data in the global heap 103 to the data in the thread-local heap 102, data being referenced in step 1020 is migrated. When data migration occurs frequently, referenceable data may be allocated to the global heap 103 in advance so that overhead of the data migration can be cut down.

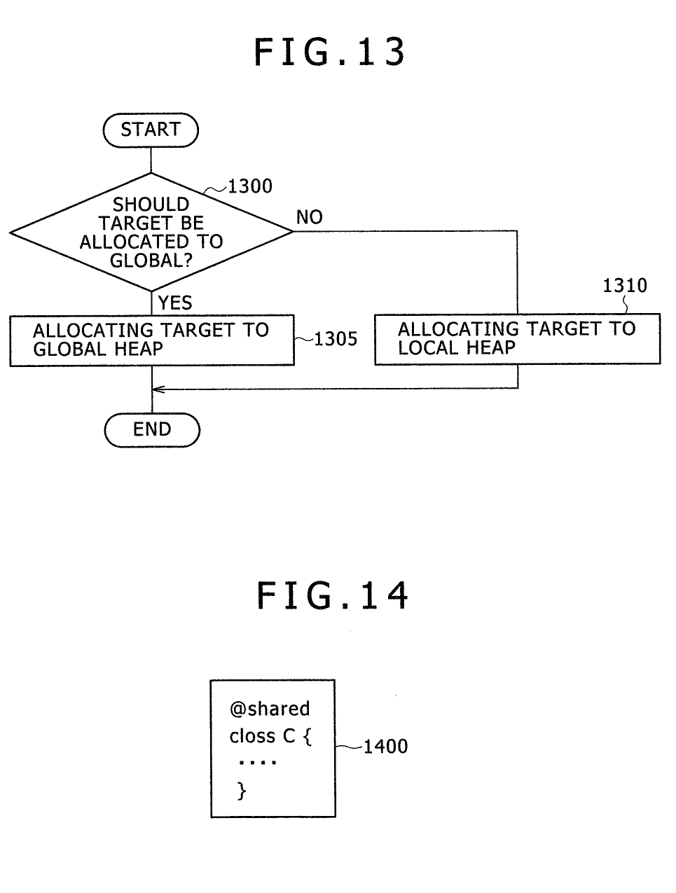

FIG. 13 illustrates a process of how to switch the data allocation to the global heap 103 and the data allocation to the thread-local heap. In step 1300, it is checked whether the allocation target data has a type of the data allocated to the global heap 103. If so, in step 1305, the data is allocated to the global heap 103. Otherwise, in step 1310, the data is allocated to the thread-local heap 102.

In step 1300, the decision regarding whether or not the target data has the same type as the data allocated to the global heap can be made according to a user instruction in an option or program, the availability of a reference to the global data by program interpretation, result of profile interpretation during execution, or the like. An example of a user instruction in a program is shown in FIG. 14. This example indicates, by specifying program attributes 1400 for class C, that the class C is used for the global heap allocation.

According to the present invention, data allocation areas following the execution of threads can be determined externally by an instruction from the program, for example. Therefore, a program designer or program creator can allocate data as desired in a way to reduce the overhead of data migration.

What is claimed is:

1. A memory management method, comprising:
creating, in correspondence to a program, a thread-local heap for each of a plurality of threads operating in parallel and a global heap shared by the threads into a memory; and
allocating data referenced by each of the threads to the corresponding thread-local heap, and allocating data referenced from other threads, excluding the threads with allocated data, to the global heap.

2. The memory management method according to claim 1, wherein, if data allocated to the thread-local heap is referenced from other threads excluding the threads with allocated data, the data allocated to the thread-local heap is migrated to the global heap prior to making the reference.

3. The memory management method according to claim 1, wherein garbage collection is executed in a thread-local heap corresponding to each of the respective threads, while maintaining other threads excluding the threads with allocated data in an execution state.

4. The memory management method according to claim 1, wherein the program determines which one of the thread-local heap or the global heap the data is to be allocated to.

5. A computer, comprising:
a memory including, in correspondence to a program, a thread-local heap for each of a plurality of threads and a global heap shared by the threads; and
a processor operating each of the threads in parallel, allocating data referenced by each of the threads to the corresponding thread-local heap according to the operation, and allocating data referenced from other threads, excluding the threads with allocated data, to the global heap.

6. The computer according to claim 5, wherein, if data allocated to the thread-local heap is referenced from other threads excluding the threads with allocated data, the processor migrates the data having been allocated to the thread-local heap to the global heap prior to making the reference.

7. The computer according to claim 5, wherein the processor executes garbage collection in a thread-local heap corresponding to each of the respective threads, while maintaining other threads excluding the threads with allocated data in an execution state.
